(19) United States
(12) Patent Application Publication
(10) Pub. No.: US 2022/0180302 A1
(43) Pub. Date: Jun. 9, 2022

(54) SYSTEM AND METHOD FOR INVENTORY MANAGEMENT AND MULTIMEDIA CONTENT DELIVERY

(71) Applicant: MaxDelivery, LLC, New York, NY (US)

(72) Inventor: Christopher Siragusa, New York, NY (US)

(21) Appl. No.: 17/542,286

(22) Filed: Dec. 3, 2021

Related U.S. Application Data
(60) Provisional application No. 63/121,798, filed on Dec. 4, 2020.

(51) Int. Cl. G06Q 10/08; G06Q 30/06

(52) U.S. Cl. CPC G06Q 10/087; G06Q 30/0601

(57) ABSTRACT

A system and method of real-time processing and remote display of specific instances of products to efficiently shop remotely on an electronic commerce platform and to manage product inventory in warehouses. In some embodiments, the real-time processing includes a machine learning model that can take as input information about the quality of an instance of a product within an image over a period of time and generates a highly probable quality prediction of new products within new images, generated in real-time from warehouse apparatus, from that information, based on what it learns from a previously captured dataset of high-quality sample images containing instances of products of ranging quality. The systems and methods described herein overcome the imprecision of conventional remote shopping systems using proxy images of products that are not indicative of the quality of the instances of products actually received.

### CROSS-REFERENCE TO RELATED APPLICATIONS

This application claims priority to U.S. Provisional Patent Application Ser. No. 63/121,798, filed on Dec. 4, 2020, the contents of which are herein incorporated by reference in its entirety and for all purposes.

### FIELD

The present disclosure relates generally to customer shopping, including methods, systems, apparatus, and computer processing to implement the same, and more specifically, but not exclusively, to methods and systems for managing real-time inventory and allowing customers to remotely preview and select specific instances of products for pickup and delivery.

### BACKGROUND

Electronic commerce via the internet allows a customer to shop from the comfort of their own home. Customers can view a large catalog of items, select what they wish to purchase, add them to their online shopping cart, and check out. Online shopping offers many benefits and conveniences of shopping at local stores and has become an ever-increasing share of the retail economy. However, the existing paradigm suffers in product categories where individual items are differentiated and have variability on size and/or quality, such as fresh meats, vegetables, art, pets, livestock, etc. For these products, one unique item of a product may be more desirable for a shopper than a different one.

Conventional online shopping systems require customers to place orders for products without knowing exactly what those products will be. Customers shopping remotely may decide to purchase a produce or meat product based on a pristine picture that acts as a proxy for the various actual products, only to get an actual product, which is markedly different from the proxy, at the end of the process. This difference can cause frustration and concern for customers, resulting in them needing to go to a local store to buy replacements, defeating the major draw of the online shopping and delivery paradigm, and resulting in less acceptance of online shopping for differentiated items.

For example, one downfall of conventional online shopping systems is that customers shopping remotely are unable to actually peruse the inventory online in much the same way that they would peruse the available inventory in a local store. Local store shopping often involves walking past presentations of specific products—all with slightly different shapes, sizes, and colors—allowing each customer to select the item that he or she specifically wishes to buy. The differences amongst these items of products that can change the customer's satisfaction with the purchase is vast and unique for every product, making it very difficult for customers to give instructions to order pickers regarding their mindset. And, in some cases, customers may have visceral reactions to certain products for reasons that they may not be able to fully articulate, which makes describing those desires impossible. Without real-time visual browsing of the actual available inventory, the online shopping experience for differentiated products is inferior to in-person local store shopping.

Another downfall of these conventional online shopping systems is that vendors do not manage inventory in sufficient detail such that quality and freshness can be remotely expressed in real-time. While vendors attempt to keep track of the number of items of a product in different stores, current systems have no real-time ability to maintain an accurate count and only allow substitutions for products that are found to be out of stock while attempting to fulfill an order that has already been placed by a customer. Vendors do not track quality and freshness of individual products in a manner that a customer can utilize to assist him or her in deciding to purchase a product. The appearance of items of a product is generalized to a proxy by necessity as current systems lack the granularity of detail necessary for adequate simulation of real-time visual browsing of the actual available inventory in-person.

In view of the foregoing, a need exists for an improved system for real-time data management and transmission on an online shopping platform to provide a customer with more detailed information needed to make an informed purchase or acquisition, and which provides a vendor with the means to review and process units of product into order of quality and freshness in real time for the customer's benefit.

### BRIEF DESCRIPTION OF THE DRAWINGS

FIG. 1 is an exemplary top-level functional block diagram illustrating the data flow through one embodiment of a remote shopping system.

FIG. 2 is an exemplary top-level diagram illustrating one embodiment of the product display screen on the user interface of the customer device of FIG. 1.

FIG. 3 is an exemplary diagram illustrating one embodiment of at least one inventory system of FIG. 1.

FIG. 4 is an exemplary flow diagram illustrating one embodiment of a process for displaying an item to and reserving an item for the customer using the system for remote shopping of FIG. 1.

FIG. 5 is an exemplary flow diagram illustrating one embodiment of a process for fulfilling the customer order of an item using the inventory system of FIG. 3.

FIG. 6 is an exemplary diagram illustrating another embodiment of at least one inventory system of FIG. 1.

FIG. 7 is an exemplary flow diagram illustrating one embodiment of a process for adding inventory using the inventory system of FIG. 6.

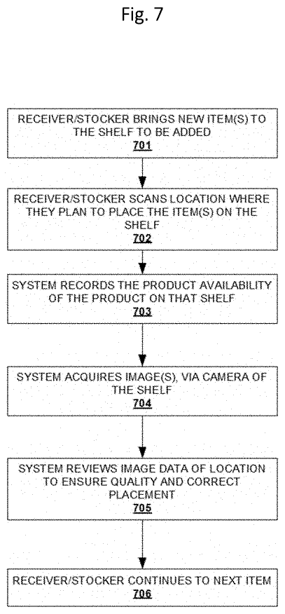

FIG. 8 is an exemplary flow diagram illustrating one embodiment of a process for continually verifying the inventory using the warehouse management system of FIG. 6.

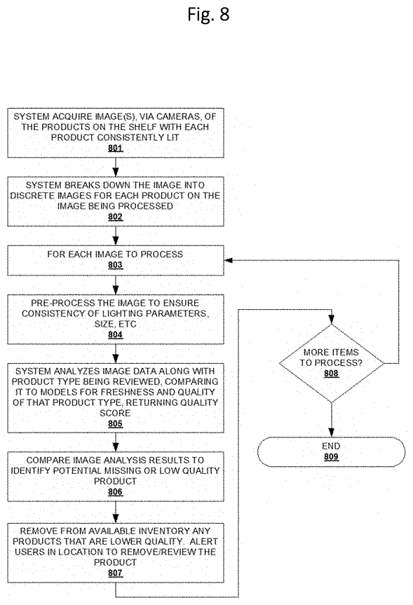

It should be noted that the Figures are not drawn to scale and that elements of similar structures or functions are generally represented by like reference numerals for illustrative purposes throughout the Figures. It also should be noted that the Figures are only intended to facilitate the description of the preferred embodiments. The Figures do not illustrate every aspect of the described embodiments and do not limit the scope of the present disclosure.

### DETAILED DESCRIPTION OF PREFERRED EMBODIMENTS

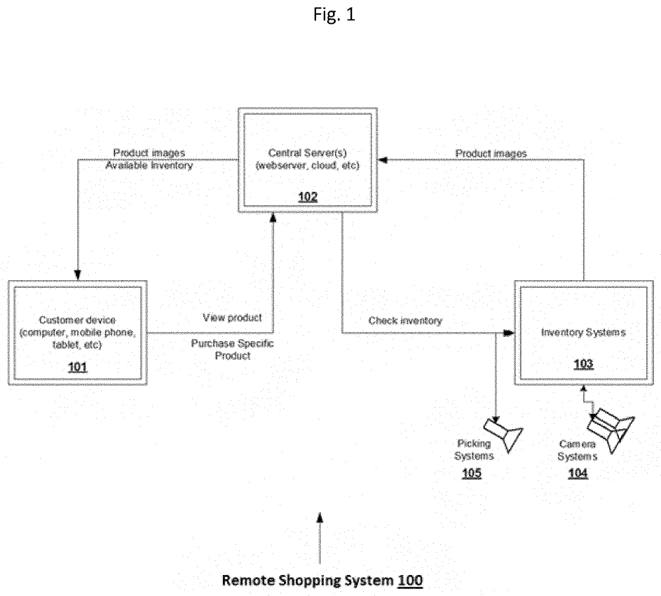

Because conventional online shopping systems cannot adequately capture the information needed to make an informed purchase or acquisition and cannot provide a means to review and process items of a product into order of quality and freshness in real-time for the customer's benefit, an improved remote shopping system that can capture additional information about units of product in real time and provide that information to customers shopping online can prove desirable. This result can be achieved, according to one embodiment disclosed herein, by a remote shopping system 100 as illustrated in FIG. 1 that allows for customers to approximate the in-store perusal experience for differentiated products by allowing customers to view actual images and details of each unit of product that is being offered and by allowing them to select and reserve that item for their individual purchase. Included in the remote shopping system of FIG. 1 are exemplary sub-systems to manage the inventory selection, shelving, picking, and possible freshness checking, ensuring that customers can reliably receive the fresh products to their liking.

In one aspect, the remote shopping system 100 allows for a customer shopping remotely to view live or semi-live footage of specific product inventory, select which specific items he or she would like to examine and purchase, and have that specific item reserved for only him or her. The remote shopping system 100 can be used, for example, by an online grocery store, allowing the customers to view the virtual butcher case, and select exactly which cut of meat they would prefer. Therefore, the remote shopping system 100 allows customers to remotely order goods or products for delivery or pickup with the same choices that they would receive during an in-person shopping experience.

With reference to FIG. 1, the remote shopping system 100 includes a customer device 101 to view and purchase specific products from at least one central server 102. The customer device 101 can be a network-connected device that a customer can use to view and communicate and can include, but is not limited to, computers, mobile devices, tablets, etc. The customer device 101 can access a user interface, for example, a vendor's website on a browser or a native mobile application, hosted on the central server 102. The customer device 101 can send a customer request to at least one central server 102 to view a specific product page which may have individualized inventory (e.g., a page showing a steak or vegetable available for sale). When the request is sent to the central server 102 via a data connection (e.g., a mobile network or an Internet connection), the central server 102 can look in the database for the latest images and/or video feed, which can be taken in real time or near-real time, from at least one inventory system 103, which can include one or more vendor stores and/or warehouses owned by a single vendor or a combination of unique vendors. At least one inventory system 103 can then check to see if the images that it has already taken and processed are recent enough, if new ones need to be taken, or if a live stream of the products needs to be initiated or directed to the central server 102. If the inventory system 103 needs updated information, it can access a camera system 104 to get the latest images or video available of the specific location(s) requested.

When images are received from the camera system 104, the inventory system 103 can then pre-process those images in its internal databases. Pre-processing includes, but is not limited to, isolating the products or items requested (e.g., to remove any other products or items which may be in the same camera frame), standardizing lighting levels across all items being viewed (e.g., to ensure as similar a set of pictures as can be obtained in potential varying light levels), and splitting the images into individualized items. Once pre-processing is complete, images are returned and/or streamed to at least one central server 102 along with details on the location within the inventory system 103 that the item within each image can be located. This location data can be customized as desired, but can include (x, y) coordinates on a shelf, physical measurements on the shelf (e.g., inches from top and left edge), or other designation for use in the central server 102 to catalog the items of products in its images as may be appropriate.

Upon receipt of the latest images from at least one inventory system 103, the central server 102 validates the products returned from at least one inventory system 103 to confirm that they are reserved for purchase by customers. The central server 102 can include a database (not shown), such as a persistent relational database or in-memory information structures, where the database stores each item of a product and whether a customer has reserved that item for purchase. Any items that had been previously reserved for sale can then have their images and/or live stream locations blocked, greyed out, masked, or have some other visual indication added to them to highlight to the customer device 101 that the item is not available at this time. These updated images, live-streams, or other visual representations can then be sent back to the customer device 101 where they can be displayed to the customer, along with metadata indicating which products are currently available for sale.

### Reserving Items and Fulfilling Orders

The user interface on the customer device 101 displays to the customer specific items of products with respective images uploaded from at least one central server 102. The customer can then select specific items of products they would like to buy through the user interface specific to the customer device 101 (e.g., web site, native mobile application or other), allowing the customer to select any item of a product that is currently available. When the customer picks a specific item of a product, the customer device 101 can send a request for that item to the central server 102, requesting to reserve that item for said customer. The central server 102 can then re-check the database of item availability to verify that the item is available and then, if the item is available, reserve the item in a blocking fashion to ensure singular reservation for the customer. The central server 102 then checks with at least one inventory system 103 to verify again that the item of the product is still in the correct location. The inventory system 103 can check quality checks for the item to ensure that the quality of the item is acceptable.

The central server 102 returns the updated inventory images to the customer device 101 with the specific item of the product selected by the customer marked appropriately as reserved, along with the remaining latest available inventory, providing visual updates to the customer that the item has been successfully reserved for them.

In other aspects, the present disclosure is directed to the software implemented on the remote shopping system 100 and corresponding computer-implemented methods that perform the various functions to effectuate the viewing, selection, and reservation of the individual products, along with systems and methods to ensure that the customer receives the exact product that he or she selected in the online system. Some functions performed by the remote shopping system 100 include updating and publishing the product images in real-time or near-real-time, allocating and reserving selected inventory, preventing multiple customers from ordering the same product, and managing inventory to ensure that customers receive the exact product they ordered, as will be further described below.

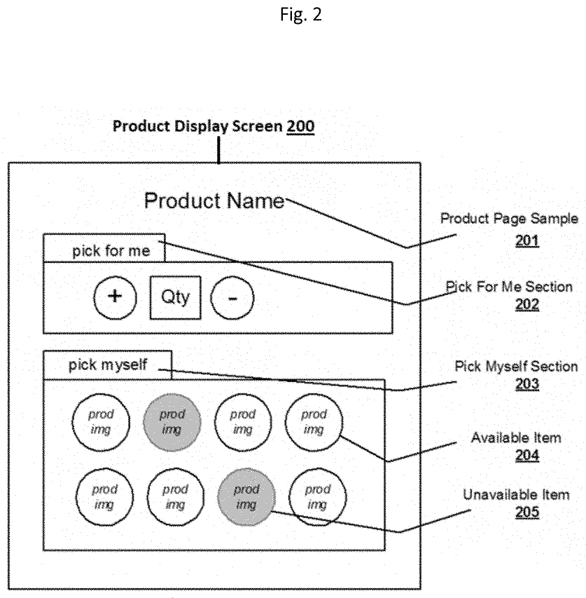

FIG. 2 illustrates a top-level diagram of a product display screen 200 that a customer might see on customer device 101 when attempting to purchase a specific item of a product. This layout is not intended to be limiting and it is expected that differing media and differing styles over time may cause the screen to be laid out significantly differently than the FIG. 2 would indicate. It is understood that various designs and modifications for what is shown in FIG. 2 can be used and are part of this disclosure.

On the product display screen 200 of FIG. 2, some key information in a product page sample 201 can be shown about the product which can include: the name of the product, generic images, sizes, descriptions, ingredients, notes, customer reviews, etc.

Specific items of a product in a vendor's catalog of products can be based on flags or other mechanisms on one or more product information records maintained, for example, on at least one central server 102. These product flags can be used by at least one inventory system 103 to define those products that need special treatment and those that are more standardized (e.g., paper products). Special treatment products are products which are not uniform in size, shape, appearance, and freshness. For example, an item of fresh fruits and vegetables, fresh meats, fresh fish, flowers, or other items which are not pre-packaged and uniform can be markedly different in quality, size, freshness, and desirability from another item of the same product. The designation of whether a product would require special treatment can be done by the vendor (e.g. some vendors may think that Chicken breasts are uniform enough, others may store them as special treatment products).

For special treatment products, the product display screen 200 of FIG. 2 can display one or more sections to the customer. For example, as shown in FIG. 2, a pick for me section 202 and a pick myself section 203 can present the customer with various operations for selecting an item for purchase. The pick for me section 202 is used by customers who may not be concerned with picking individual products or who may be more time constrained. Choosing this option would allow the inventory system 103 to determine the item of a product to choose. This selection can be based upon any number of criteria subject to business rules of the vendor using factors including, but not limited to, product quality score, product age, product size, or product location details. In other embodiments, vendors may elect to have separate inventory available for orders placed using the pick for me section 202 option, allowing vendors to more quickly take and pack items for customers less concerned about choosing specific items.

For customers who would prefer to choose the individual items, the pick myself section 203 shows the customers the details of the products that are available. There are many different potential embodiments that can be envisioned in this section, which will depend upon many factors including, but not limited to, bandwidth requirements, current design norms, screen sizes, and technical implementation of the camera system 104 and the availability of images associated with items. In some embodiments, the customer can click a location on the screen and a “drop down” can reveal the available inventory laid out in a grid with each real time static shot shown, allowing the customer to look through each one, potentially zoom in on the product, and decide if it is the best product.

Another embodiment of the pick myself section 203 can show products in a more “realistic” viewing profile that is more familiar to them. For example, a product can be laid out to resemble a placement that customers might be familiar with in their in-person shopping, or a product can be virtually “stacked” in a manner similar to what they would see in a section of a local store.

In other embodiments of the pick myself section 203, customers can see and choose the products in a more intuitive fashion in virtual reality or alternative reality.

The customer can view the list of items that are shown, with some items being flagged as available items 204 and unavailable items 205. It is understood that there can be many mechanisms available for indicating which items are available items 204 or unavailable items 205, including, but not limited to, greying out of items, applying other visual masks to the item, overlaying icons or images over unavailable items 205, or simply hiding unavailable items 205 altogether from the customer.

To update and publish product images, the inventory system 103 manages the inventory of the differentiated products and catalogs their exact locations. This process can be accomplished by several methods including, but not limited to, camera detection of products, regimented shelving (e.g., by subdividing shelves with one product per sub-shelf), or by other means to allow the system to track each product. Once each item is identified, the inventory system 103 may need to segregate each product image into discrete images of each item of product for processing. The means for this segregation may vary based upon the database, ranging from simple division into grids in the case of regimented shelving, to computer vision edge detection algorithms for other cases.

Once the customer has seen the pictures or video of the available items 204 in the pick myself section 203, the customer can then request at least one item to purchase by selecting the image associated with at least one item. The customer device 101 sends a selection map (not shown) detailing the requested items to at least one central server 102. In different embodiments, the selection map can include, but is not limited to, (x, y) coordinates on a picture of the item that the want to select or a picture number from a list of separate item pictures that might have been returned. The central server 102 can send the selection map to at least one inventory system 103, which can, in real time, check that the requested items are still available (e.g., that another customer has not simultaneously chosen the same product) in the internal database or other memory of server 308, check to ensure the requested items are still available, check to ensure requested items are at the correct quality, and send this collected information to the central server 102. If the requested items are still available and of the correct quality, at least one central server database 102 or at least one server internal database 308 or other memory can be updated to indicate that the requested items are reserved, ensuring that other customers cannot purchase the requested items while the requested items are reserved. If the requested items are either not available or not of the correct quality, at least one central server database 102 or at least one server internal database 308 or other memory can be updated to indicate this information. The central server 102 then sends the collected information to the customer device 101 where the user interface returns to the customer a notification (not shown) of success or a notification of failure to reserve items in real time. Should the customer not complete the order for some reason, the remote shopping system can release these reservations after some set period of time or action by the customer, freeing up that item to be requested by another customer.

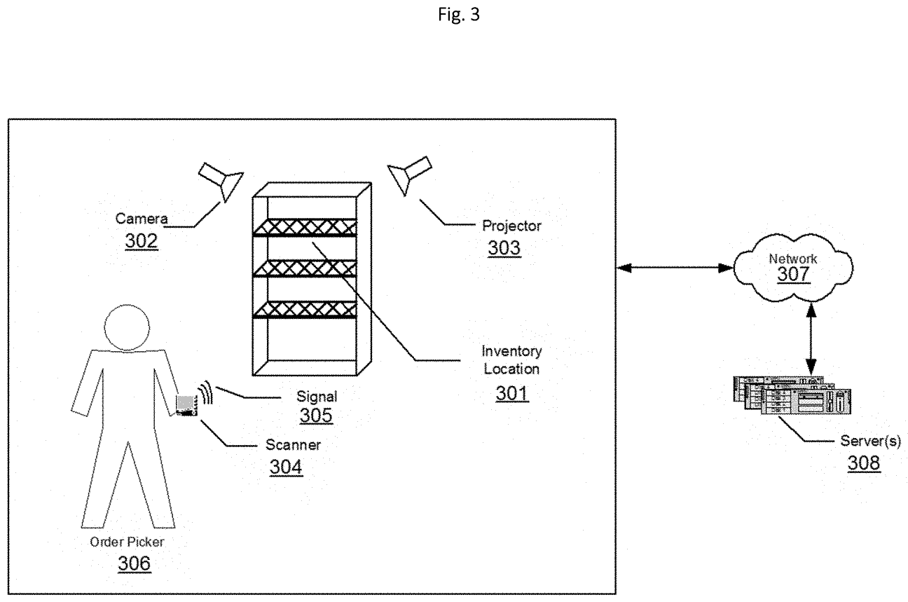

FIG. 3 is a diagram illustrating one embodiment of the inventory system 103, where the physical inventory is located in a warehouse or store facility (facility) that is using at least one picking system 105 and at least camera system 104 to assist order pickers 306 to take the correct items that the customer requested at the inventory location 301. A facility is comprised of one or more physical structures or areas within which the inventory location 301 is located. Each inventory location 301 can hold physical goods including, but not limited to, fresh meats, produce, fish, drinks, or household items, groceries, medicines, and so forth. The inventory location 301 can be at fixed locations upon a floor, or designed to be mobile, with robotic or conveyor services to transport the shelves to the required locations. The inventory location 301 can use internal refrigeration (not shown) of its own to hold different shelves at different temperatures or relative humidity, or may or may not be within refrigerated or frozen areas of the facility, depending upon the requirements of the products stored within the inventory location 301. The inventory location 301 includes at least one standard shelving unit with multiple shelves and sub-shelves holding product, or it can include one large pallet-like structure upon which inventory is stacked. Similarly, the inventory location 301 can include an enclosed box, which can be relocated in three dimensions across the warehouse, subject to the needs of the facility.

FIG. 3 shows exemplary features of the inventory system 103 to properly track the inventory in the inventory location 301 in real-time, including one or more of each of a camera 302, a projector 303, a network 307, and a server 308, within which the software-based processes of at least one inventory system 103 may operate.

Each inventory location 301 may be connected to at least one camera system 104 by a variety of cameras 302, allowing inventory systems 103 to properly input what is located on the shelf. In different embodiments, these cameras might, depending on vendor requirement, record all of the products on the shelf or only record the instances of the products being added and removed. In other instances, cameras 302 might record the location of each inventory location 301 relative to other inventory locations 301 for routing purposes, which refers to routing of order pickers 306 within the facility, or to pinpoint the exact location of each inventory location 301 within the facility. Touch sensors and buttons might be used on inventory locations 301 as convenient means for allowing staff to interact with inventory locations 301 and to indicate that certain actions were taken or need to be taken. Screens and other display devices might be integrated into inventory locations 301 allowing staff members to see status of items, items that need to be picked up, or other details that might need to be displayed there. Weight sensors on inventory locations 301 can be used to track the load on inventory locations 301 and to validate the items at each inventory location 301, including when items are added and removed from each inventory location 301. Radio-frequency identification (RFID) readers or other Near Field Communication (NFC) devices can be integrated with the inventory location 301, allowing the system to detect when individuals or products are interacting with inventory locations 301 without the need to scan badges or have individuals provide other identifying details. Infrared thermometer sensors can be added to the inventory locations 301 to ensure that all of the products are continually being kept at optimized temperatures and to help detect signs of potential spoilage before they become visually apparent.

The inventory locations 301 can access the network 307 via wired or wireless communication routers, allowing inventory location 301 to send information back and forth to the server 308 that host inventory systems 103. These networks can utilize a variety of different technologies, including WiFi, Bluetooth or other NFC communications, etc.

Also depicted in FIG. 3 is a representation of an order picker 306, which can be an entity (e.g., an automated picking system (not shown), an employee or contractor of the facility, or a robotic agent performing the picking operation) that takes items from the inventory location 301 for fulfillment of customer orders. When customer orders are completed through the central server 102 and ready for processing, the inventory system 103 may assign the order to a selected order picker 306. Robotic agents can include automated machines that will fully take each item from inventory locations 301 and place into a pick basket or can refer to “vending machine” style picking systems whereby the items are stored individually in inventory locations and are pulled from the system in a fully automated manner.

The inventory locations 301 may also be connected to at least one picker system 105 by a variety of projectors 303 or other devices for guiding the order picker 306 to the requested items. The projector 303 can be a series of LEDs or other lights which can be controlled, highlighting items to be picked, LED/LCD projectors to cast spotlights upon certain locations, or other similar technologies meant to send directed light at specific places in inventory locations 301. Each order picker 306, whether automated or not, can utilize another embodiment of a picker system 105, which in this embodiment is comprised of a scanner 304 to emit at least one electronic signal 305. The scanner 304 is a device that can detect information about an item or inventory location 301 and use that information to assist in identifying the item or inventory location 301 being interacted with. In some embodiments, the scanner 304 might be a barcode scanner which can detect 2D or 3D barcode formats on products or shelves and get a unique code from the scan. Other embodiments of scanner 304 can include video or camera scanners, which would image a product in the field of view, compare the object to known other instances and determine the correct classification. Still other scanners can include NFC scanners which interacts with radio tags on inventory locations 301 or on items of a product, allowing the scanner 304 to assist in identifying the inventory location 301 or specific items.

For the scanner 304 to interact with the inventory location 301 or the network 307, a transmitter can be included, for example to enable radio, WiFi, Bluetooth, infrared, or other wireless signal technology. As the selected order picker 306 moves through the facility, they can continually interact with the network 307 or the server 308 to gauge position, have work assigned, or complete the work required.

Once the customer's order is completed, the remote shopping system 100 can send the order to at least one inventory system 103 from which the order is being fulfilled. At that location, the order picker 306 can be assigned to the order, with directions to pick and take the requested items. The inventory system 103 can direct the order picker 306 to the inventory location 301 where the product is being stored along with location information on how to pick the exact item. The location information can vary based upon how the requested item was stored in the inventory location 301, the technology being used by the order picker, and other local factors. For example, an order picker 306 equipped with a scanner 304 with a screen can see the actual image of the product, can see the exact location of the requested item within inventory location 301, and can scan the inventory location 301 to verify that they took the correct product. In another example, a projector 303 located at the inventory location 301 can, upon the approach of the order picker, highlight the requested item with a light to ensure the order picker 306 takes the requested item. Different approaches are envisioned for different products and layouts and these examples should not be read as exhaustive. After the order picker 306 has picked the requested item, the inventory system 301 can check at least one camera system 104 to ensure that the correct requested item was removed from the inventory location 301 by the order picker 306, initiating an alert if the camera system 104 detects the item still in place.

### Process for Reserving Items and Fulfilling Orders

Pre-processing the images of each product may take place in inventory systems 103 at any point to ensure that accurate representations of the physical product are being presented to the customer on the product display screen 200. Pre-processing tasks take place in inventory systems 103 and involve standardization of lighting and saturation levels to ensure even lighting parameters across each item, centering and removal of “background” details for the item, allowing the customer to focus on the details of the item itself and not the surrounding noise, and other image manipulation techniques designed to ensure the most accurate clean picture is being returned to the customer. Once pre-processing is complete, images are returned and/or streamed to at least one central server 102 along with details on where within inventory systems 103 the items within each image were located.

Each image may then be subjected to a series of reviews by the remote shopping system 100 to ensure the product is up to quality standards and should be displayed to the customer. Similar to the way that a butcher will review the steaks in a butcher case and remove any that are not to their quality standard, the remote shopping system 100 can evaluate the quality of items via their respective images within at least one central server 102 to proactively check for any items of products that do not meet vendor guidelines. For example, a neural network can be trained with a large database of digital images of high-quality and low-quality examples of a particular class of product with associated product reviews, using iterative training sets that add incorrectly chosen images from the previous set to the current set to develop criteria that allows the neural network to look at an item and output a quality score. The quality score can then be compared to internal company metrics for quality and, should the quality score be insufficient, the product can be proactively removed from the available inventory and staff members dispatched to review and/or remove the product physically.

Products which pass the above reviews may then be displayed on the user interface on the customer device 101. Customers wishing to buy an item may then have the option to have the order picker at the facility pick the product for them, or to pick the exact product themselves. Should the customer indicate that he or she wishes to pick the product themselves by entering the pick myself section 203, the inventory system 103 can retrieve the latest available product images, real time video or other mechanism for showing the product to the customer. The inventory system 103 can cross-reference those products with its own database or other historical record to see which, if any, of those items had already been selected by other customers for purchase or were otherwise unavailable. The unavailable items 205 can then be grayed out on the product display screen 200 or other visual clues can be added to the product display screen 200 to alert the customer that they would be unavailable when requested. The images, videos, or other mechanisms of available individual products can be returned from the inventory system 103 to the customer device 101 via the central server 102 for the customer's examination. Upon this return of images, the user interface on the customer device 101 can then style these images to help the customer see that these are real-time individual images and to help make the experience feel more like an in-store experience that the customer might be familiar with.

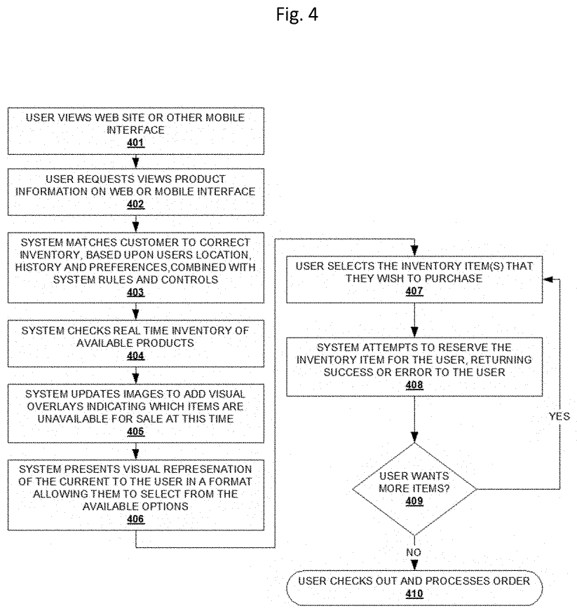

As discussed, the remote shopping system 100 facilitates displaying products to the customer, as shown in FIG. 4 by performing the steps of transmitting data to a user interface on the customer device 101 in step 401, receiving data at the central server 102 generated from a customer request to view product information in step 402, matching the customer to the correct inventory location 301 based upon customer data and remote shopping system 100 rules and controls in step 403, checking real time inventory of available items 204 at inventory location 301 in step 404, updating images on the customer device 101 via at least one central server 102 and adding visual overlays indicating which items are unavailable items 205 in step 405, and presenting a visual representation of the available items 204 in a familiar format that allows the customer to select from the available options.

In performing these steps and others, the remote shopping system 100 may match the customer to the available items 204 using a variety of criteria. Some embodiments move the customer to available items 204 by delivery address being mapped to a specific zone. Other embodiments have different customers assigned to respective facilities based upon some combination of location, historical preferences, rules and controls, etc. In other embodiments, customers might be assigned to a facility by examining which location is best suited to be able to serve their needs (e.g. which facility has the product in stock). The remote shopping system 100 checks the real-time inventory of the product by initially checking the database in the central server 102 for the total number of available items 204 and displaying that to the user interface on the customer device 101. For products that have been indicated within at least one inventory system 103 as requiring real-time updating of more detailed information of specific items of the product within its product information records, at least one central server 102 sends requests to at least one inventory system 103 for updated images and/or video streams of the specific items of a product. These requests will be received by at least one server 308 via the network 307 within each respective inventory system 103, which may then interact with the camera system 104 to get the latest images. The images are sent along with the metadata, which allows the central server 102 to identify which picture belongs to which product, to at least one central server via the network 307. The images can be saved to at least one server 308 within the inventory system 103 before being sent to the central servers 102. If the images show that an item is available, the central server 102 can update images of available items in the pick myself section 203 of the product display screen 200 on the user interface of the customer device 101. Items can be unavailable for a variety of reasons including, but not limited to, being in someone else's shopping cart, being in this customer's shopping cart, being on an existing order, being removed for quality, being damaged, pending review by managers, and others. Design choices with respect to the presentation of available items 204 and the masking of unavailable items 205 may evolve over time with technology and stylistic standards. If the images show that an item is unavailable, the central server 102 can remove or mask the unavailable item 205 on the user interface of the customer device 101.

As discussed, the remote shopping system 100 facilitates requests to reserve inventory, as shown in FIG. 4 by performing the steps of receiving data generated from a customer selection of the available item 204 on the product display screen 200 on the user interface of the customer device 101 to the central server 102 in step 407, attempting to reserve the item via the inventory system 103 in step 408, providing the customer with the ability to choose more items on the product display screen 200 in step 409, and sending data generated from the customer checking out through the central server 102 to the inventory system 103 in step 410.

In performing these steps and others, the customer can select the available item 204 in the pick myself section 203 on the product display screen 200 on the user interface of the customer device 101 via a mouse click, screen touch, gesture, or other mechanism and upon selecting the item, a real time call can be made to the central server(s) 102, using technologies such as AJAX calls using JSON over HTTPS via the data connection. The call can contain information about the selected item, including the location of the item as indicated in the metadata of the item image that the customer selected. Item information can identify the item via a variety of mechanisms, including but not limited to coordinates on an image, individual image numbers, image maps sent with the original request and others. The item information being sent should be sufficient to allow at least one central server 102 to identify the item that is being requested.

The central server 102 can then send a request to the inventory system 301 to reserve the product in the facility and can indicate to the customer on the product display screen 200 on the user interface of the customer device 101 that the available item 204 is now reserved. The central server 102 can also update the database with an updated image or status of the product indicating that the item is now unavailable. The central server 102 can use the updated database information to update the list of available items 204 and unavailable items 205 on the product display screen 200 in real time to give other customers immediate feedback that the item was reserved by the customer, to show that the item is newly unavailable due to another customer reserving it, or to show any other results from the attempt to purchase.

Should the customer wish to purchase additional pieces, the customer can select another available item 204. Once the customer has completed selecting the items that he or she wishes to purchase, he or she can complete the order by checking out on the product display screen 200 of the user interface, whereby the items that he or she selected on the user interface may be delivered directly to them.

Other protocols can be used that allow for secure real-time communication between the customer device 101, the central server 102, and the server 308 in the inventory system 103 with the option for a response, including, but not limited to, HTTPS calls and page refreshes, direct TCP/IP calls, or proprietary protocols. The call can also contain information about the customer purchasing the items, or this information can be stored in the customer's session on the central server 102 or uploaded onto server 308 later, subject to specific needs and business requirements of the retailer.

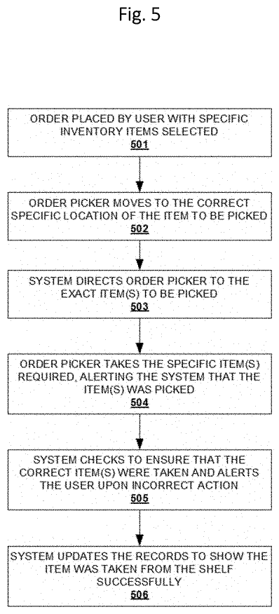

As discussed, the inventory system 103 facilitates fulfillment of a customer order at a facility, as shown in FIG. 5 by performing the steps of assigning the order to the order picker 306 when received from at least one central server 102 in step 501, directing the order picker 306 to move to the inventory location 301 of the requested item in step 502, directing the order picker 306 to the exact location of the requested item within the inventory location 301 in step 503, initiating an alert via the picker system 105 when the order picker 306 takes the requested item in step 504, checking to ensure that the item taken by the order picker 306 is the requested item in step 505, and initiating an update of the database to show that the requested item was taken from the inventory location 301 successfully.

In performing these steps and others, different embodiments of the assignment of the order picker 306, the scanner 304, the camera system 304, the signal 305 can be applied. In one embodiment, assignment of order picker 306 can be assigned to the order via a round-robin fashion of available staff. In other embodiments, assignment of order picker 306 may be “zone picking” where order picker 306 is assigned to take all the requested items from a select set of inventory location 301 in their zone. In yet other installations, assignment of order picker 306 can be accomplished based upon specializations of certain products. Other potential embodiments are envisioned and included in this design.

The different embodiments of the order picker 306 can use a scanner 304, which can be handheld, can show the correct inventory location 301 to pick and take from, and can potentially show the exact product locations or pictures of the exact product being selected. In another embodiment, order picker 306 can receive a printed paper picking ticket showing the inventory location 301 of the requested items. In other embodiments, the inventory location 301 may be routed to where the order picker 306 is located by robotic automated control. In other embodiments, the order picker 306 can utilize screens mounted near the inventory location 301 showing all requested items from each inventory location 301 in a zone-based scheme. Other embodiments might include voice picking options or robotic options which would move inventory location 301 to order picker 306 and possibly highlight the item to be picked and taken.

The alert after the item is taken can be accomplished by scanning the product or location using scanner 304. Other embodiments might include pressing a button or other sensor on the inventory location 301 to alert the system that the requested item was picked. Another embodiment might automatically detect the taking of the requested item through weight sensors, cameras, or other sensors located on inventory location 301. In other embodiments, the order picker 306 is comprised of robotic picking systems that can pick and take the individual items automatically by using predefined locations on the inventory location 301 or by using artificial intelligence integrations to allow for simultaneous correct taking of the selected product.

Once the alert is initiated, the signal 305 emitted from the scanner 304 identifying where the order picker 306 took the item can initialize the camera system 104 to detect the item being removed. The signal 305 which can be from a variety of local networking protocols, including, but not limited to Bluetooth, WiFi, NFC, and others. The system can be updated to show that the item has been successfully taken via scanning of the product using the scanner 304, by detection via the camera 302 or by other means in various embodiments.

Upon successful detection via camera system 104 that the correct requested item has been taken by the order picker 306, the scanner 304 or camera 302 can access the network 307 to update at least one central server 102 database with the information that the requested item was taken from the inventory location 301 successfully. The inventory system 103 can then be alerted again to initiate a check of the remaining locations at at least one inventory location 301 to validate that the correct items were taken and that no other incorrect products were taken by the order picker 306.

### Restocking Inventory

Periodically, at least one inventory location 301 may need to be restocked within the facility. A receiver/stocker may have items of products that need to be added to the available inventory for sale. Another embodiment of the inventory system 103 can direct a receiver/stocker to the inventory location 301 for that product. Upon arrival at the inventory location 301, the inventory system 103 can allow the receiver/stocker to stock the product at any location that is free at the inventory location 301, or the inventory system 103 can allocate and direct the receiver/stocker to a specific location within the inventory location 301 by use of specific locations or light projectors or other means. The receiver/stocker can then scan the location and the item to alert the inventory system 103 that the item has been placed on the shelf. The inventory system 103 can then re-index the images of the items of the products in the inventory location 301, verify that the item is correctly located, check the quality of the product that was shelved, and update the inventory system 103 internal databases or other memory. Should the item fail any of those checks, the system can then alert the receiver/stocker in real-time to ensure that the receiver/stocker correct the issue before the item is offered to the customer.

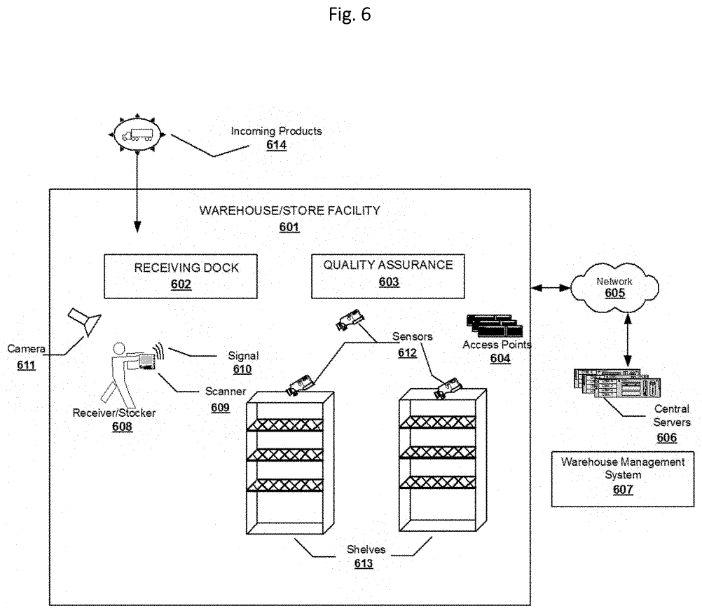

FIG. 6 is a diagram illustrating another embodiment of the inventory system 103 where the physical inventory is located in a warehouse/store facility 601 that contains at least one camera 611, shelves 613 at the inventory locations 301, and at least one sensor to assist a receiver/stocker 608 to replenish the location and have the inventory system 103 verify and offer the item for sale. The warehouse/store facility 601 comprises one or more physical structures or areas within which one or more inventory location(s) 301 may be held. Each warehouse/store facility 601 may hold physical goods such as fresh meats, produce, fish, drinks, or household items, groceries, medicines, and so forth. Each inventory location 301 may or may not be within refrigerated or frozen areas of the warehouse/store facility 601, depending upon the requirements of the products stored within the warehouse/store facility 601. The warehouse/store facility 601 may include one more areas designated for different functions with regard to inventory processing and handling. The facility warehouse/store facility 601 in FIG. 6 includes a receiving dock 602 and a quality assurance 603 area.

The receiving dock 602, may be configured to accept products and deliveries from suppliers, shown as incoming products 614 in FIG. 6, for initial processing and receiving into the facility warehouse/store facility 601. For example, the receiving dock 602 may include a loading dock for receiving trucks from suppliers via pallets or other large conveyances with pallet jacks or forklifts to transport the items. In other embodiments, the receiving dock 602 may include freight doors for individual product deliveries. In other embodiments, the receiving dock 602 may be an internal location for receiving products processed in other parts of the warehouse/store facility 601, such as meat or cheese cut and wrapped in a processing area and brought to the receiving dock for shelving.

In some embodiments, products received at receiving dock 602 may require initial processing before proceeding to the shelves 613 in the warehouse/store facility 601, In some embodiments, products may be directed to the quality assurance 603 area. For example, produce or meats being received may require detailed inspection and/or weighing and labeling in the quality assurance area 603. In other embodiments, products may need to be indexed and scanned into the warehouse management system 607 before proceeding further.

Throughout the warehouse/store facility 601, the cameras 611 and the sensors 612 may be connected to the warehouse management system 607, allowing warehouse management system 607 to properly understand the activity of receiver/stocker 608 and the current location and quality status of incoming products 614. In some embodiments, the cameras 611 might record all of the products on the shelf during the instances of the products being added and removed. In other instances, cameras might track the progress and movement of all of the receivers/stockers 608 throughout the warehouse/store facility 601 facility, allowing for proper routing and tracking of progress. In other embodiments, proximity sensors, cameras, network sensors and weight sensors might record the location of shelves 613, for routing purposes, or to pinpoint the exact location of a shelf within the facility.

The shelves 613 are used to store products that may be available for sale. In some embodiments, the shelves 613 may consist of some fixed locations with specific addresses to allow for easy direction to the location, such as aisles, sides, shelves and possibly bins within shelves. These locations can be logically organized in such a manner to allow receiver/stocker 608 and order picker 306 to quickly and easily locate an item and navigate to a location where an item is stocked.

The shelves 613 may or may not be within refrigerated or frozen areas of the facility, depending upon the requirements of the products stored within the shelves 613. Similarly, the shelves 613 may have internal refrigeration, allowing for the shelves 613 to be held at different temperatures or relative humidity. The shelves 613 may be comprised of a standard shelving unit with multiple shelves and sub-shelves holding product, or it may consist of one large pallet-like structure upon which inventory is stacked. In a different embodiment, the shelves 613 may be comprised of an enclosed box which can be relocated in three dimensions across the warehouse, subject to the needs of the facility. In another embodiment, the shelves 613 may consist of some mobile locations which can be brought to receiver/stocker 608 or order picker 306 and may consist of large shelving units with shelves and bins or may consist of individual bins which can be moved independently through the warehouse by means of robotic controls to bring them to receiver/stocker 608 or order picker 306.

One or more receiver/stocker 608 may operate in the warehouse to bring items from receiving dock 602 or quality assurance 603 area to the correct shelves 613. Each receiver/stocker 608 may be an employee or contractor of the organization or may be a robotic agent performing the stocking operation, depending upon the embodiment of the inventory system 103. Robotic agents operating as receiver/stocker 608 may require processing units, motors, cameras and other sensors, and batteries to allow them to autonomously operate in the warehouse/store facility 601.

Each receiver/stocker 608, whether automated or not, may require a scanner 609 which may emit signal 610. The scanners 609 are devices that can detect information about an item or shelf 613 to use that information to identify the object being interacted with. In some embodiments, the scanner 609 can be a barcode scanner which can detect 2D or 3D barcode formats on products or shelves and get a unique code from the scan. Other embodiments of the scanner 609 include video or camera scanners that can image a product in the field of view, compare the object to known other instances and determine the correct classification. In still other embodiments, the scanners 609 might involve NFC scanners which would interact with radio tags on shelves 613 or on the items of products, allowing the scanner 609 to identify the shelves 613 or the item of product. Other potential scanner technologies are assumed to be included in the description for the purposes of this diagram.

Touch sensors and buttons can be used on the shelves 613 as convenient means for allowing staff to interact with the shelves 613 and to indicate that certain actions were taken or need to be taken. Screens and other display devices can be integrated into the shelves 613 allowing staff members to see status of items on the shelf, products that need to be checked, or other details which might need to be displayed there. Weight sensors on the shelves 613 or on the floors can be used to track the loading on the shelves 613 and to validate the items on the shelf 613, including when items are added and removed. RFID readers or other NFC devices can be integrated with shelves 613 or areas around the warehouse/store facility 601, allowing the system to detect when staff members or products are interacting with shelves 613 without the need to scan badges or other identifying details. Infrared thermometer sensors might be added to shelves 613 to ensure that all of the items of products are continually being kept at optimized temperatures and to help detect signs of potential spoilage before they become visually apparent.

Control of all the receivers/stockers 608 in the facility warehouse/store facility 601 via the signals 610 emitted from the scanners 609 in the possession of receivers/stockers 608, along with processing of all the camera 611 and the sensor 612 data can route through access points 604 distributed throughout the facility warehouse/store facility 601. The other agents in the facility warehouse/store facility 601 can communicate through access points 604 using wired or wireless communication protocols such as TCP/IP, Ethernet, WiFi, Bluetooth, NFC, infrared communication protocols or other means of encoding data to communicate. In some embodiments, the access points 604 may communicate over secure protocols to ensure security of the data.

Data accessed through the access points 604 is passed through the network 605 to the central servers 606, which can host the warehouse management system 607. The warehouse management system 607 can interact with the receivers/stockers 608, the scanners 609, the cameras 611, the sensors 612, and the shelves 613 to direct and control the operations in the facility warehouse/store facility 601. In one implementation, the warehouse management system 607 can direct the receiver/stocker 608 through the facility warehouse/store facility 601 to optimize the routes that the receiver/stocker 608 must traverse while ensuring that all incoming products 614 are put in the correct shelves 613. In other embodiments, the warehouse management system 607 can track the shelving and processing of all products, checking for product freshness, product rotation or other potential issues. In some embodiments, the warehouse management system 607 can track the location and details of every product on every shelf 613 throughout the warehouse/store facility 601 facility.

### Process for Restocking Inventory

As discussed, the inventory system 103 facilitates the processing and shelving by the receiver/stocker 608 of items received, as shown in FIG. 6 by performing the steps of the guiding the receiver/stocker 608 in bringing the incoming product 614 via the receiving dock 602 and quality assurance 603 area to the shelf 613 the item is to be added in step 701, instructing the receiver/stocker 608 to use the scanner 609 to scan the shelf 613 where the new item is to be added in step 702, recording via the warehouse management system 703 the product availability on the shelf 613 in step 703, acquiring images of the incoming product 614 via camera 611 in step 704, reviewing image data of location to ensure quality and correct placement in step 705, and instructing the receiver/stocker 608 to continue to the next incoming product 614 if another is present.

In performing these steps and others, different embodiments of the receiver/stocker 608 and the scanner 609 can be used. In one embodiment, the receiver/stocker 608 may be an employee or contractor who carries the incoming product 614 to the shelf 613. In other embodiments, the receiver/stocker 608 may transport the incoming product 614 to the shelf 613 using cart, u-boat platform truck, pallet, forklift or other means of conveyance. In other embodiments, the receiver/stocker 608 may transport the incoming product 614 to the shelf shelves 613 through fixed or adjustable conveyor systems controlled by the warehouse management system 607. In other embodiments, the receiver/stocker 608 may be a robotic or automated agent that fully delivers the incoming product 614 to the correct shelf 613 without any other interactions required. In other embodiments, the receiver/stocker 608 may remain near the receiving dock 602 while the shelf 613 moves autonomously to the receiver/stocker's 608 location using robotic shelf moving robots. In another embodiment, the shelves 613 may consist of individual bins that can be autonomously routed to the location of the receiver/stocker 608. Once the receiver/stocker 608 arrives at the shelf 613, the receiver/stocker 608 may scan the location to alert the warehouse management system 607 that the receiver/stocker 608 is in the correct location by means of the scanner 609 scanning a barcode on the location. In other embodiments, the scanner 609 may use NFC or other wireless technology to register that the receiver/stocker 608 is in the correct location to process the shelving. In other embodiments, the scanner 609 may use the cameras 611 or other visual sensors to validate the correct location.

In performing these steps and others, the warehouse management system 607 may interact with the receiver/stocker 608, the camera 611, and the scanner 607 in different ways. The warehouse management system 607 may direct the receiver/stocker 608 to a specific sub-location on the shelf 613 that is available. In other embodiments, the receiver/stocker 608 may be able to pick any location on the shelf 613 that is available and place the incoming product 614 into that space. In other embodiments, the warehouse management system 607 may instruct the receiver/stocker 608 to rotate the stock and move existing items to new spaces in the shelf, placing the incoming product 614 into spaces behind them. The scan of the receiver/stocker 608 after the receiver/stocker 608 physically shelves the product may update the warehouse management system 607 with the information that the incoming product 614 is shelved. The update may be done using scanner 609 using barcodes on the product. In other embodiments, the update may be done using camera or image-based scanners 609 within the camera systems 104 to record the product as it is put on the shelf. Images can be taken from the camera systems 104, comprising cameras 611 and other sensors integrated into shelves 613, and stored in JPG, GIF, PNG, video formats such as MPGs or other live video formats, or other electronic formats on the central servers 606 for use by the warehouse management system 607. Other embodiments of updating the warehouse management system 607 might include pressing a button or other sensor on shelf 613 to alert the warehouse management system 607 that the incoming product 614 was shelved. Another implementation might automatically update warehouse management system 607 that the incoming product 614 was shelved through weight sensors, cameras, or other sensors located on shelves 613. In other embodiments, robotic shelving systems can shelve the individual items automatically by using defined locations on the shelf 613 or by using artificial intelligence integrations to allow for exact placement of the incoming product 614.

The warehouse management system 607 can process the images from the camera systems 104 to check for quality. If the incoming product's 614 quality standard is not up to the correct level, an error can be returned to the receiver/stocker 608 to examine and possibly reposition or adjust the incoming product 614 on the shelf 613. If the image check is successful, the receiver/stocker 608 can continue to the next incoming product 614 if one exists.

### Process for Checking Quality of Incoming Products

As discussed, the warehouse management system 607 facilitates the validation of the freshness, quality and presence of incoming products 614 on the shelf 613 using the camera system 104, as shown in FIG. 6 by receiving images of the products on the shelf with each product consistently lit via cameras 611 in step 801, breaking the image into discrete images for each incoming product 614 on the image in step 802, placing each discrete image into a sequence to be processed in step 803, pre-processing the discrete image to ensure consistency of lighting parameters, size, etc. in step 804, comparing the discrete image to model images of products to create quality score for freshness and quality of that product type in step 805, comparing quality scores to identify missing or low-quality incoming products 614 in step 806, removing the identified products via the central server 606 and alerting the user, who can be the receiver/stocker 608, in location to remove/review the product in step 807, searching for more images to process in step 808, and if none are present, ending the process in step 809.

In performing these steps and others, enhancements to this process may occur with additional enhancements or equipment such as integration of infrared thermometers, etc. The images from camera 611 can be of a specific item on the shelf 613 or can be of a group of products arrayed in the inventory location 301. Initial image will be raw image that may have varying light levels across images, making consistent comparison difficult. In some embodiments, the warehouse management system 607 can examine the images to normalize the data by the inclusion of a standard color wheel within each image which can then be used to normalize images. In other embodiments, the warehouse management system 607 can normalize images by statistical means by checking against known curves for the products and backgrounds. Nothing in this section shall be construed to assume that the images obtained in step 801 are solely with visual light cameras. In some embodiments, additional infrared or ultraviolet cameras may be included in place of or in addition to the visual light cameras, giving a wider view of the products being examined. Image and sub-image may refer to visual light images, infrared images, ultraviolet images, or some combination thereof.

Once the overall image has been normalized, the warehouse management system 607 can parse the image into discrete sub-images by ensuring that each product is stored in a defined space at the inventory location 301, allowing for a simple slicing of the image along those boundaries. In other embodiments, edge detection algorithms can be used to find and isolate each individual product in the image. In another implementation, a neural network can be used to identify each individual object within the image of the known type of objects at the inventory location 301 and the image can be broken down along those borders. Multiple other embodiments exist to accomplish the same goal of efficiently parsing the images into sub-images and should be included in this description.

Each sub-image can be reviewed for quality against known models of freshness by trained convolutional neural networks or other artificial neural networks to analyze the images, returning a quality score vector of different criteria analyzed. In other embodiments, grouped pixel analysis can be used to average the coloring of the pixels across different areas of the image, looking for specific features, including blemishes or discolorations, that would render the incoming product 614 unsaleable, returning a low-quality score if said unsaleable features exist. In other embodiments, infrared images might be analyzed for “hotspots” on the image indicating potential bacterial growth, returning a low-quality score for the image if such hotspots exist. Other potential image analysis techniques will be readily apparent to those skilled in the art and the examples should not be limiting, but merely illustrative.

The warehouse management system 607 can pre-set threshold quality scores and rules for determining freshness, such as removing anything with a quality score below a set level. Other embodiments might look at each product's quality scoring over time to determine relative differences and adjust relative levels. Another implementation might take the quality scoring metrics from the images and combine that with other information about the product such as length of time on shelf, average length of time on shelf, etc. and use the various criteria together to make the business decision to remove the product. Multiple different embodiments may be in use across one system, as each individual product type may require different rules and criteria to properly evaluate (e.g., evaluating steak freshness may require different rules than evaluating bananas or salmon).

Overall, with the advent of the additional processing, systems, and methods described, the customer can have the ability to see and order the exact products that they want. This is a marked change from the existing conventional systems of online shopping and can allow customers to remotely order non-standard products with more peace of mind, as they can be given a choice and control over their purchase that is non-existent in conventional remote shopping systems.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

1. A system for real-time processing and remote display of specific instances of products for remote shopping on an online commerce platform, the system comprising:
an inventory system for maintaining the specific instances of the products that are available for remote shopping;
a central server in operable connection over a data network with the inventory system;
a database of the central server for maintaining at least one image corresponding to the specific instances of products for remote shopping; and
at least one customer device having a display screen for presenting a user interface,
wherein the user interface provides access to a website of the central server, the website representing a product listing that includes one or more categories of the specific instances of products, and
upon a request from the at least one customer device to the central server to view the specific instances of products that are available for a selected category, the central server queries the database for the images corresponding to the specific instances of products available for the selected category and displays to the at least one customer device the images returned by the central server in response to the request.

2. The system of claim 1, wherein said inventory system maintains the database of the at least one image and updates each of the at least one images at least one of periodically at fixed intervals or in response to the request from the at least one customer device.

3. The system of claim 2, further comprising at least one camera physically disposed within the inventory system, and wherein said inventory system updates each of the at least one images comprises capturing a new image via the at least one camera for at least one image of the at least one images and storing the new image in the database.

4. The system of claim 3, wherein said inventory system further preprocesses the new image prior to storing in the database by at least one of isolating an image of the specific instance of the product standardizing lighting within the new image, and splitting the image into sub-images.

5. The system of claim 4, further comprising a neural network in operable connection with the central server, wherein said inventory system pre-processes the new image using the neural network.

6. The system of claim 1, wherein said inventory system further provides location data defining a physical location of the inventory system where the specific instance of the product is disposed.

7. The system of claim 1, wherein said central server further validates the images returned by the central server in response to the request to confirm availability based on a digital flag associated with each image.

8. The system of claim 1, wherein the database further associates with each image of the specific instance of the product with metadata that includes a name of the product, generic images of the product, a size of the specific instance of the product, a description of the product, and customer reviews, the website of the central server presented on the user interface further displays a portion of the metadata.

9. The system of claim 1, wherein said inventory system defines one or more inventory locations, each inventory location associated with a unique physical allocation of the inventory system, and wherein said central server displays to the at least one customer device a selected inventory location with the images returned by the central server in response to the request, the selected inventory location indicating where the specific instance of the product is located.

10. A method for real-time processing and remote display of specific instances of products for remote shopping on an online commerce platform, the method comprising:
providing a website from a central server to a user interface presented on a display screen of a customer device, the website representing a product listing that includes one or more categories of the specific instances of products;
receiving a request from the customer device at the central server to view a selected category of the one or more categories of the specific instances of products;
querying a database of the central server for images corresponding to the specific instances of products for remote shopping based on the received request, the database being maintained by an inventory system for physically maintaining the specific instances of the products that are available for remote shopping; and
displaying to the customer device the images returned by the central server in response to the request.

11. The method of claim 10, further comprising:
maintaining, via the inventory system, the database of the at least one image; and
updating, via the inventory system, each of the at least one images at least one of periodically at fixed intervals or in response to the received request from the customer device.

12. The method of claim 11, wherein said updating each of the at least one images comprises capturing a new image via at least one camera physically disposed within the inventory system for at least one image of the at least one images and storing the new image in the database.

13. The method of claim 12, further comprising pre-processing, via the inventory system, the new image prior to storing in the database by at least one of isolating an image of the specific instance of the product, standardizing lighting within the new image, and splitting the image into sub-images.

14. The method of claim 13, wherein said pre-processing the new image comprises providing the new image to a neural network in operable connection with the central server.

15. The method of claim 1, further comprising providing location data defining a physical location of the inventory system where the specific instance of the product is disposed.

16. The method of claim 1, further comprising validating the images returned by the central server in response to the request to confirm availability based on a digital flag associated with each image.

17. A non-transitory computer-readable storage medium for real-time processing and remote display of specific instances of products for remote shopping on an online commerce platform, wherein the non-transitory computer-readable storage medium includes instructions that, when executed by at least one processor of a computing system, cause the computing system to perform a method comprising:
providing a website from a central server to a user interface presented on a display screen of a customer device, the website representing a product listing that includes one or more categories of the specific instances of products;
receiving a request from the customer device at the central server to view a selected category of the one or more categories of the specific instances of products;
querying a database of the central server for images corresponding to the specific instances of products for remote shopping based on the received request, the database being maintained by an inventory system for physically maintaining the specific instances of the products that are available for remote shopping; and
displaying to the customer device the images returned by the central server in response to the request.

18. The non-transitory computer-readable storage medium of claim 17, further comprising:
maintaining, via the inventory system, the database of the at least one image; and
updating, via the inventory system, each of the at least one images at least one of periodically at fixed intervals or in response to the received request from the customer device.
